(19) United States
(12) Patent Application Publication
(10) Pub. No.: US 2022/0348836 A1
(43) Pub. Date: Nov. 3, 2022

(54) PRODUCTION OF FUEL PELLETS INCLUDING HEMP AND/OR KENAF WASTE BYPRODUCT

(71) Applicant: University of Kentucky Research Foundation, Lexington, KY (US)

(72) Inventors: Thomas Keene, Lexington, KY (US); Darrell Neal Taulbee, Lexington, KY (US)

(21) Appl. No.: 17/862,585

(22) Filed: Jul. 12, 2022

Related U.S. Application Data
(63) Continuation-in-part of application No. 16/843,435, filed on Apr. 8, 2020, now Pat. No. 11,414,614.
(60) Provisional application No. 62/832,332, filed on Apr. 11, 2019.

(51) Int. Cl. C10L 5/04; C10L 5/08; C10L 5/36; C10L 5/44

(52) U.S. Cl. CPC C10L 5/04; C10L 5/08; C10L 5/363; C10L 5/44; C10L 2200/04

(57) ABSTRACT

A fuel pellet has a body made from a mixture of (a) 1-99 weight percent hemp byproduct, kenaf byproduct or a combination thereof and (b) 1-99 weight percent coal fines. A related method of making a fuel pellet includes the steps of: (1) mixing together (a) a hemp byproduct, a kenaf byproduct or a hemp byproduct and a kenaf byproduct and (b) coal fines to form a pelleting mixture; and (2) compressing or extruding the pelleting mixture and forming the fuel pellet in the absence of any added binder.

### RELATED APPLICATION

This application claims priority to U.S. patent application Ser. No. 16/843,435 filed on Apr. 8, 2020, which claims the benefit of U.S. Provisional Patent Application Ser. No. 62/832,332 filed on Apr. 11, 2019 which are hereby incorporated by reference in their entirety.

### TECHNICAL FIELD

This document relates generally to the energy field and, more particularly, to a new and improved binderless fuel pellet as well as to a method of making the same.

### BACKGROUND

An estimated 2 billion tons of recoverable coal fines have been discarded in impoundments in the United states of America, mostly east of the Mississippi River, with millions of tons of additional material added each year. It has been further estimated that over 600 million tons of coal fines can be found in impoundments and gob piles in the Commonwealth of Kentucky alone. This represents both a substantial lost resource as well as potential environmental hazards.

It is possible to economically clean and separate a low-ash coal-fines product but it is not economically feasible to utilize such recovered fines due to obstacles associated with handling and transport (hangs up in hoppers and rail cars) and high moisture content (i.e. low net heating value or BTU content).

Forming the coal fines into agglomerates via briquetting, pelletization, extrusion, or other agglomeration techniques yields a product that is amenable to transport, storage, and handling in conventional coal-processing equipment. However, such an approach has historically been hampered by the scarcity of effective binders that can provide the required durability at a price which is not prohibitive.

In recent years, the Commonwealth of Kentucky has become a leader in the production of hemp with a number of large-scale producers and processing plants located throughout the state. The primary use for the hemp is to produce a high market CBD oil via an extraction process. This process removes less than 10% of the total weight leaving over 90% as a waste byproduct. There is currently no market for the hemp byproduct that remains after processing meaning it must be stored on site or slated for landfill disposal at a typical cost of at least $45-$50 per ton.

Kenaf processing also produces substantial amounts of kenaf byproduct. Again, there is no true market for kenaf byproduct which must, therefore, be stored on site or slated for landfill disposal at similar high costs.

Our work has shown that good quality fuel pellets can be made from a blend of (a) fine coal and (b) hemp byproduct, kenaf byproduct or a combination of hemp and kenaf byproduct. Importantly, this work has shown that it is not necessary to dry the coal fines prior to pelletizing as good quality pellets have been made using coal fines containing moderate (about 10 to 15 percent moisture) to high (above 15 percent moisture) levels of moisture. This has obvious favorable economic implications.

Producing fuel pellets from blends of (a) coal fines and (b) hemp byproducts, kenaf byproducts or hemp and kenaf byproducts not only avoids potential landfill costs for those byproducts but it also provides a means to transport and utilize the coal fines in combustors, particularly in coal-fired utility boilers, using the existing infrastructure. In addition, since hemp and kenaf are renewable biomass, burning hemp and/or kenaf infused pellets to produce electricity may qualify for valuable renewable energy credits (RECs).

It should also be noted that due to restrictions sometimes contained in their fuel clause, some power producers can only pay for fuels in which a specified minimum of the fuel value derives from a fossil fuel source, a requirement which coal-hemp, coal-kenaf and coal-hemp-kenaf byproduct pellets can meet. Thus, while fuel pellets made from hemp byproduct and/or kenaf byproduct may be able to garner RECs and avoid disposal costs, adding coal fines can provide additional benefits and flexibility.

### SUMMARY

For purposes of this document, the term “pellet” refers to a discrete body including a pellet, a puck, a briquette, a compressed aggregate or the like. Hemp waste byproduct refers to, but is not necessarily limited to, remnants from both the bast fiber (outer, stringy material) and the shive or hurd fiber (inner woody, pithy material) and the solid waste that remains following cannabinoid extraction or a combination thereof. Kenaf waste byproduct refers to, but is not necessarily limited to, waste that remains following fiber processing of the harvested kenaf stalks. It may include remnants of both the bast fiber and the shive or hurd fiber. Coal fines refers to coal fines of less than 2.54 cm (1.0 inch) in size and having a moisture content of between 2.5 and 14 weight percent which may be sourced from, but not limited to, cleaned run of mine coal, reject from coal preparation plants or coal crushing operations, or waste material such as that stored in waste impoundments or gob piles. Such a fuel pellet has the necessary structural integrity to be shipped, stored and/or efficiently fed into a combustor or firebox of a utility boiler by the same equipment used to feed coal

In accordance with the purposes and benefits set forth herein, a new and improved fuel pellet is provided. That fuel pellet comprises, consists essentially of or consists of a pellet body made from a mixture of (a) 1-99 weight percent hemp byproduct, kenaf byproduct or a combination thereof and (b) 1-99 weight percent coal fines.

In at least one of the many possible embodiments, the pellet body is binder-free. For purposes of this document, “binder free” and “binder-free” mean no pellet binder of a type known in the art to be useful in the production of fuel pellets needs to be added to the fuel pellet 10 in order for it to have the desired structural integrity to be shipped, stored or fed into a combustor or firebox of a utility boiler by the same equipment used to feed coal.

In at least one embodiment, the fuel pellet includes 10-90 weight percent hemp byproduct, kenaf byproduct or a combination thereof and 10-90 weight percent coal fines. In at least one embodiment, the pellet body includes 20-80 weight percent hemp byproduct, kenaf byproduct or a combination thereof and 20-80 weight percent coal fines. In at least one embodiment, the pellet body includes 33-50 weight percent hemp byproduct, kenaf byproduct or a combination thereof and 50-67 weight percent coal fines.

In accordance with an additional aspect, a new and improved method is provided for making a binder-free fuel pellet comprising, consisting essentially of or consisting of the steps of (1) mixing together (a) a hemp byproduct, a kenaf byproduct or a hemp byproduct and a kenaf byproduct and (b) coal fines to form a pelleting mixture and (2) compressing or extruding the pelleting mixture and forming the binder-free fuel pellet in the absence of any added binder.

In at least one of the many possible embodiments of the method, the method includes the step of using remnants from both bast fiber and shive remaining following fiber processing of hemp as the hemp byproduct. In at least one embodiment, the method includes the step of using coal fines less than 2.54 cm in size and having a moisture content of between 2.5 and 20 weight percent. In at least one possible embodiment, the method includes the step of using waste hemp byproduct following extraction of a cannabinoid oil from hemp.

In the following description there are shown and described several possible embodiments of the new and improved fuel pellet and the method of making the same. As it should be realized, the fuel pellet and method are capable of other, different embodiments and its several details are capable of modification in various obvious aspects without departing from the fuel pellet and method as set forth and described in the following claims. Accordingly, the drawing FIGURES and descriptions should be regarded as illustrative in nature and not as restrictive.

### BRIEF DESCRIPTION OF THE DRAWING FIGURES

The accompanying drawing FIGURES incorporated herein and forming a part of the patent specification, illustrate several aspects of the fuel pellet and the method and together with the description serve to explain certain principles thereof.

FIG. 1 is a perspective view of the new and improved fuel pellet.

### DETAILED DESCRIPTION

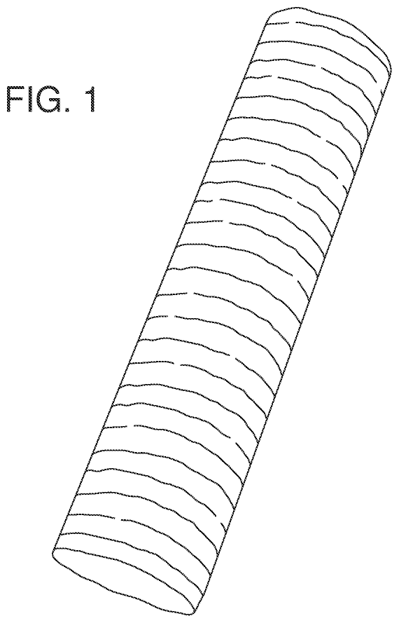

Reference is now made to FIG. 1 which illustrates the new and improved fuel pellet 10. As will become apparent from the following description, the fuel pellet 10 is a binder-free fuel pellet: that is a fuel pellet free from the addition of any fuel pellet binder of a type known to those skilled in the art. This substantially reduces the cost of producing the fuel pellet thereby making the fuel pellet a more cost effective substitute for coal.

The fuel pellet 10 also has the structural integrity to be fed into the firebox of a boiler by the existing equipment used to feed coal. As such, it should be appreciated that the fuel pellet 10 is characterized by a number of advantages that make it a commercially competitive product as an alternative fuel source.

The fuel pellet 10 includes a pellet body 12 made from a mixture of: (a) 10-90 weight percent hemp byproduct, kenaf byproduct or a combination thereof and (b) 10-90 weight percent coal fines. For purposes of this document, hemp byproduct includes, but is not necessarily limited to, waste that remains following fiber processing, including remnants from both the bast fiber (outer, stingy material) and the shive or hurd fiber (inner woody, pithy material) and the solid waste that remains following extraction of cannabidiol (CBD) or other cannabinoid oils or a combination thereof. For purposes of this document, kenaf byproduct includes, but is not necessarily limited to, waste that remains following fiber processing of the harvested kenaf stalks. It can include remnants from both the bast fiber (outer, stringy material) and the shive or hurd fiber (inner woody, pithy material).

In some embodiments, the pellet body is made from a mixture of: (a) 20-80 weight percent hemp byproduct, kenaf byproduct or a combination thereof and (b) 20-80 weight percent coal fines. In still some other embodiments, the pellet body is made from a mixture of: (a) 33-50 weight percent hemp byproduct, kenaf byproduct or a combination thereof and (b) 50-67 weight percent coal fines.

In at least one possible embodiment of the fuel pellet 10, coal fines includes coal fines of less than 2.54 cm (1.0 inch) in size and having a moisture content of between 2.5 and 20 weight percent. In some embodiments, the coal fines have a moisture content of between 5 and 20 weight percent. In still other embodiments, the coal fines have a moisture content between 10 and 20 weight percent. In yet other embodiments, the coal fines have a moisture content between 15 and 20 weight percent.

Significantly, the pellet body may be binder free: meaning no pellet binder of a type known in the art to be useful in the production of fuel pellets needs to be added to the fuel pellet 10 in order for it to have the desired structural integrity to be shipped, stored or fed into a combustor or firebox of a utility boiler by the same equipment used to feed coal.

In one or more of the many possible embodiments, the fuel pellet 10 consists essentially of the physical properties and characteristics noted above. By this, it is meant that the fuel pellet includes all of the ingredients specifically noted above (i.e. hemp byproduct and/or kenaf byproduct and coal fines) with any other components known to be useful in fuel pellets, all in the absence of any addition of a fuel pellet binder of a type known to be used for such purpose.

A method for making the fuel pellet 10 includes the steps of: (1) mixing together (a) a hemp byproduct, a kenaf byproduct or a hemp byproduct and a kenaf byproduct and (b) coal fines to form a pelleting mixture and (2) compressing or extruding the pelleting mixture and forming the binder-free fuel pellet in the absence of any added binder. The pressure applied generally exceeds 100 psi.

In one or more of the many possible embodiments, the method may include using remnants from both bast fiber and shive remaining following fiber processing of hemp as the hemp byproduct. In one particularly useful embodiment, the method includes using waste hemp byproduct following extraction of CBD oil or other cannabinoids from hemp. Significantly, raw hemp subjected to the harsh conditions for supercritical extraction of CBD oil at high temperatures and pressures results in a hemp byproduct having unexpected binder-like properties when mixed with coal fines.

In one or more of the many possible embodiments of the method, the method 30 also includes using coal fines less than 2.54 cm in size and having a moisture content of between 2.5 and 20 weight percent. In some embodiments, those coal fines have a moisture content between 5-20 weight percent. In some embodiments, those coal fines have a moisture content between 10-20 weight percent. In some embodiments, those coal fines have a moisture content between 15-20 weight percent.

### Experimental Examples

| | Hemp | Air-dried^{a} | As received^{b} | Blend |
|---|---|---|---|---|
| | byproduct | coal fines | coal fines | moisture |
| Run # | wt % | wt % | wt % | wt % |
| 36-4 | 100% | | | 8.4% |
| 30-3 | 50.0% | 50.0% | | 7.3% |
| 31-2 | 33.3% | | 66.7% | 11.0% |

^{a}moisture—2.75%
^{b}moisture = 10.52%

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A fuel pellet, comprising:
a pellet body made from a mixture of (a) 1-99 weight percent hemp byproduct, kenaf byproduct or a combination thereof and (b) 1-99 weight percent coal fines.

2. The fuel pellet of claim 1, wherein the pellet body is binder free.

3. The fuel pellet of claim 1, including 10-90 weight percent hemp byproduct, kenaf byproduct or a combination thereof and 10-90 weight percent coal fines.

4. The fuel pellet of claim 1, including 20-80 weight percent hemp byproduct, kenaf byproduct or a combination thereof and 20-80 weight percent coal fines.

5. The fuel pellet of claim 1, including 33-50 weight percent hemp byproduct, kenaf byproduct or a combination thereof and 50-67 weight percent coal fines.

6. A fuel pellet, consisting essentially of:
a pellet body made from a mixture of (a) 1-99 weight percent hemp byproduct, kenaf byproduct or a combination thereof and (b) 1-99 weight percent coal fines.

7. The fuel pellet of claim 6, wherein the pellet body is binder free.

8. The fuel pellet of claim 6, including 10-90 weight percent hemp byproduct, kenaf byproduct or a combination thereof and 10-90 weight percent coal fines.

9. The fuel pellet of claim 6, including 20-80 weight percent hemp byproduct, kenaf byproduct or a combination thereof and 20-80 weight percent coal fines.

10. The fuel pellet of claim 6, including 33-50 weight percent hemp byproduct, kenaf byproduct or a combination thereof and 50-67 weight percent coal fines.

11. A fuel pellet, consisting of:
a pellet body made from a mixture of (a) 1-99 weight percent hemp byproduct, kenaf byproduct or a combination thereof and (b) 1-99 weight percent coal fines.

12. The fuel pellet of claim 11, wherein the pellet body is binder free.

13. The fuel pellet of claim 11, including 10-90 weight percent hemp byproduct, kenaf byproduct or a combination thereof and 10-90 weight percent coal fines.

14. The fuel pellet of claim 11, including 20-80 weight percent hemp byproduct, kenaf byproduct or a combination thereof and 20-80 weight percent coal fines.

15. The fuel pellet of claim 11, including 33-50 weight percent hemp byproduct, kenaf byproduct or a combination thereof and 50-67 weight percent coal fines.

16. A method of making a binder-free fuel pellet comprising:
mixing together (a) a hemp byproduct, a kenaf byproduct or a hemp byproduct and a kenaf byproduct and (b) coal fines to form a pelleting mixture; and
compressing or extruding the pelleting mixture and forming the binderless fuel pellet in the absence of any added binder.

17. The method of claim 16, including using remnants from both bast fiber and shive remaining following fiber processing of hemp as the hemp byproduct.

18. The method of claim 16, including using coal fines less than 2.54 cm in size and having a moisture content of between 2.5 and 20 weight percent.

19. The method of claim 16, including using waste hemp byproduct following extraction of a cannabinoid oil from hemp.
